(19) United States
(12) Patent Application Publication
(10) Pub. No.: US 2020/0074488 A1
(43) Pub. Date: Mar. 5, 2020

(54) METHODS, AND DEVICES, TO OPTIMIZE CONSUMER SUBSAMPLING FROM GROUPS OF INDEPENDENTLY MODELED AUDIENCE SEGMENTS TO ENABLE REPRESENTATIVE COMPARITIVE ANALYTICS

(71) Applicant: 4C Insights, Inc., Chicago, IL (US)

(72) Inventor: Sean Breedlove, Chicago, IL (US)

(21) Appl. No.: 16/552,406

(22) Filed: Aug. 27, 2019

Related U.S. Application Data
(60) Provisional application No. 62/723,606, filed on Aug. 28, 2018.

(51) Int. Cl. G06Q 30/02

(52) U.S. Cl. CPC G06Q 30/0204; G06Q 30/0201

(57) ABSTRACT

A method to improve the subsampling from a group of independently modeled audience segments including accessing a consumer database to retrieve propensity scores across multiple target audiences, using target audience membership data from a representative dataset to construct an overlap matrix of multiple target audiences, decomposing the overlap matrix into consumer signatures by identifying unique cliques, calculating an overlap matrix for a default assignment of target audiences in the modeled audience database, calculating consumer signatures for records in the modeled audience database based on the default assignment, calculating differences, and using the overlap matrix and consumer signature profile taken to inform an adjustment process that retains the proportional relationships of target audience sizing and overlap within the target audience selection within the modeled audience database.

### FIELD OF THE INVENTION

This disclosure relates generally to media and marketing research, more particularly, to methods to improve subsample audience segments derived from independent scoring models based on a common dataset to enhance the applicability to representative comparative audience analyses to inform the planning and activation of advertising campaigns that span both mass and addressable media vehicles.

### BRIEF SUMMARY

The present invention is directed to address the challenges presented by the advertiser and agency demand for solutions to enable converged cross-media analytics and campaign activation applied to advertising campaigns that span both mass and addressable advertising vehicles. A predominant example is the desire to leverage audience segments that have been created for digital media by matching them to large scale data sources such as cable set top box, smart television, or proprietary panels to inform viewing analyses for linear television planning. This disclosure outlines methods to leverage the input of a groups of existing audience segment scoring models in addition to a matrix of estimated audience overlap taken from a representative source to inform the selection of optimized subsamples of consumers to inform representative comparative analyses.

In a first aspect, there is provided a method to improve the subsampling from a group of independently modeled audience segments, said method being performed by a computing device arranged to connect to a consumer database comprising propensity scores across multiple target audiences, said method comprising the steps of:

(a) accessing, by said computing device, said consumer database for retrieving said propensity scores across said multiple target audiences thereby obtaining a modeled audience database,

(b) using, by said computing device, target audience membership data from a representative dataset to construct an overlap matrix of said multiple target audiences,

(c) decomposing, by said computing device, said overlap matrix into consumer signatures by identifying unique cliques comprised in said representative overlap matrix,

(d) calculating, by said computing device, an overlap matrix for a default assignment of target audiences in said modeled audience database,

(e) calculating, by said computing device, consumer signatures for records in the modeled audience database based on the default assignment,

(f) calculating, by said computing device, differences between representative dataset and initial target selection from the modeled audience database along the dimensions of the overlap matrix and consumer signature distribution,

(g) using, by said computing device, the overlap matrix and consumer signature profile taken from the representative database to inform an adjustment process that retains the proportional relationships of target audience sizing and overlap within the target audience selection within the modeled audience database.

The inventors have found a beneficial, and advantageous, way to select audiences using independent scoring models based on a common dataset to enhance the applicability to representative comparative audience analyses.

The method involves the applicability of propensity scores to an audience model and using target audience membership data from a representative dataset to construct an overlap matric of the multiple target audiences. The overlap matrix is used to create unique consumer signatures for creating a representative data source. This is again used to select a modeled audience, which have been scored using the consumer signatures.

In an example, the propensity scores range from zero to one hundred for indicating a propensity of a consumer to a target audience. It is noted that, in accordance with the present application, the propensity scores may also have difference ranges, for example between 1 to 10 or anything alike.

In a further example, each consumer signature relates to a unique assignment of target audiences in said modeled audience database.

In yet another example, each consumer signature is coupled to a respondent count indicating how often particular unique assignments of target audiences occurs.

In a further example, the step of using comprises informing said target audience selection within the modeled audience database.

In a second aspect, there is provided a computing device arranged to connect to a consumer database comprising propensity scores across multiple target audiences, wherein said computing device is arranged to improve the subsampling from a group of independently modeled audience segments, said computing device comprising:

(a) access equipment arranged for accessing said consumer database for retrieving said propensity scores across said multiple target audiences thereby obtaining a modeled audience database,

(b) process equipment arranged for using target audience membership data from a representative dataset to construct an overlap matrix of said multiple target audiences,

(c) wherein said process equipment is further arranged for decomposing said overlap matrix into consumer signatures by identifying unique cliques comprised in said representative overlap matrix,

(d) wherein said process equipment is even further arranged for calculating an overlap matrix for a default assignment of target audiences in said modeled audience database,

(e) wherein said process equipment is even further arranged for calculating consumer signatures for records in the modeled audience database based on the default assignment,

(f) wherein said process equipment is even further arranged for calculating differences between representative dataset and initial target selection from the modeled audience database along the dimensions of the overlap matrix and consumer signature distribution,

(g) wherein said process equipment is even further arranged for using the overlap matrix and consumer signature profile taken from the representative database to inform an adjustment process that retains the proportional relationships of target audience sizing and overlap within the target audience selection within the modeled audience database.

It is noted that the advantages in relation to the first aspect of the present disclosure are also applicable to the second aspect of the present disclosure, being the computing device.

In a further example, the propensity scores range from zero to one hundred for indicating a propensity of a consumer to a target audience.

In an example, each consumer signature relates to a unique assignment of target audiences in said modeled audience database.

In an example, each consumer signature is coupled to a respondent count indicating how often particular unique assignments of target audiences occurs.

In yet another example, the process equipment is arranged for informing said target audience selection within the modeled audience database.

### BRIEF DESCRIPTION OF THE DRAWINGS

FIG. 1 illustrates the process flow of leveraging the inputs of a groups of independently modeled audience segments in combination with an overlap matrix derived from a data source to inform subsampling that is optimized to inform representative comparative analyses.

FIG. 2 contains an example of records of anonymous consumer IDs with propensity scores that are the result of running independent audience expansion models seeded by a common dataset that are contained in a collection of audience segments.

FIG. 3 is an example of an estimated audience overlap matrix sourced from a representative sample used to inform the audience expansion model.

FIG. 4 represents the decomposition of the overlap matrix into the unique consumer signatures derived by leveraging graph theory to identifying the unique cliques within the set of audiences. The consumer signature target audience membership information is then combined with the overlap matrix to derive the estimated counts within each signature.

FIG. 5 illustrates the ranking of each respondent by propensity score and the selection of target audiences with a defined size of 5 each.

FIG. 6 illustrates the resultant overlap matrix of the selection by top 5 rank by propensity score and the difference from the overlap matrix from the representative dataset.

FIG. 7 illustrates the differences between the consumer signatures from the modeled audience and the representative dataset.

FIG. 8 Illustrates the adjustment process made to the target audience selection within the propensity score population to align the consumer signature distribution and overlap matrix to the target estimates defined by the representative dataset.

FIG. 9 illustrates the resultant overlap matrix of adjusted modeled audience selection and exact alignment with the overlap matrix from the representative dataset.

FIG. 10 illustrates the resultant consumer signature distribution of adjusted modeled audience selection and exact alignment with the consumer signature distribution from the representative dataset.

### DETAILED DESCRIPTION

The present invention is directed to address the challenges presented by the advertiser and agency demand for solutions to enable comparative analytics and campaign activation applied to advertising campaigns that span both mass and addressable advertising vehicles. A common example is the desire to leverage audience segments that have been created for digital media by matching them to large scale data sources such as set top box or smart television to inform viewing analyses for linear television planning. However, since these datasets are not truly census level they are used to project out to the national or local markets which requires leveraging representative subsampling and calibration to adjust for known biases. In addition, analyzing independently scored audience segments do not retain the relationships of relative sizing, overlap, and mutual exclusivity that drive the level of inter-correlation between audiences.

Some examples digital audience segments defined using social affinity data, mobile location and app install data, and consumer shopping panel data. These data sources provide a robust foundation to analyze the overlap of consumers across multiple audience definitions. Providers of these data types often provide platforms with collections of audience segments which have independently modeled for use in digital targeting, which calculate propensity scores to the consumer databases they are applied to. Performing optimized subsampling to the scored consumer databases will enhance the applicability of such audience segment data sources for use in comparative analytics.

This disclosure outlines methods to leverage the input of existing audience segment scoring models in addition to a matrix of estimated audience overlap taken from a representative source to inform the selection of optimized subsamples of consumers to inform representative comparative analyses.

The present disclosure is thus directed to a method to optimize the subsampling from a group of independently modeled audience segments, comprising (a) using a consumer database which contains propensity scores across multiple target audiences, (b) using target audience membership data from a representative dataset to construct an overlap matrix, (c) decomposing the overlap matrix into consumer signatures by identifying the unique cliques contained in the representative overlap matrix, (d) calculating an overlap matrix for the default assignment of target audiences within the modeled audience database, (e) calculating the consumer signatures for each record in the modeled audience database based on the default assignment, (f) calculating the differences between the representative dataset and initial target selection from the modeled audience database along the dimensions of the overlap matrix and consumer signature distribution, (g) Using the overlap matrix and consumer signature profile taken from the representative database to inform an adjustment process that retains the proportional relationships of target audience sizing and overlap within the target audience selection within the modeled audience database.

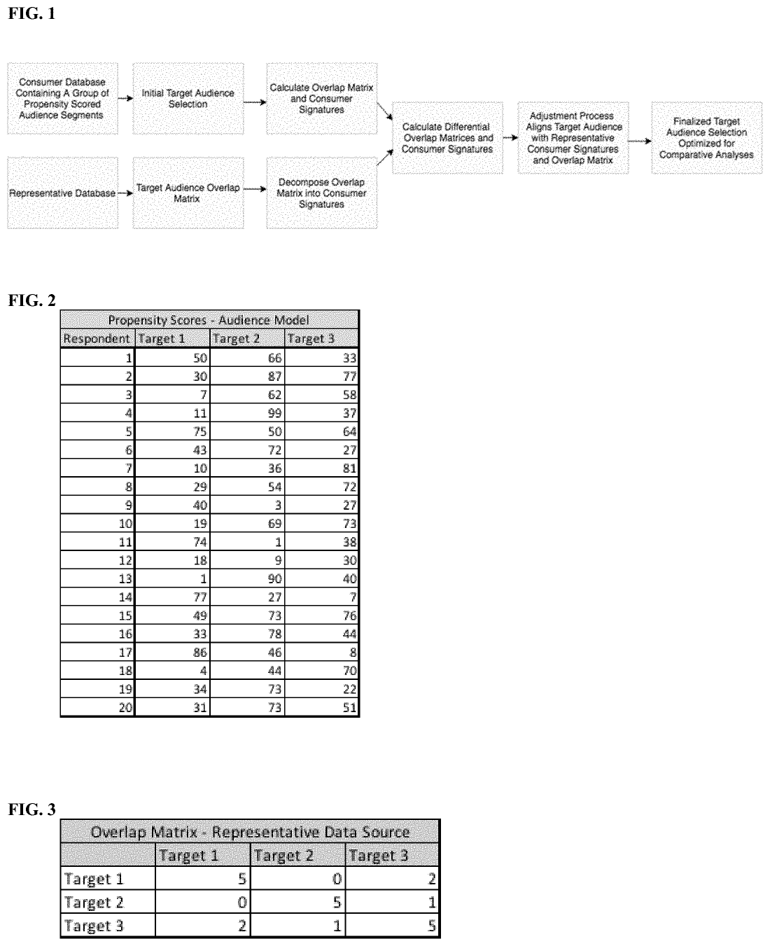

FIG. 1 illustrates a sample process flow of taking a set of propensity scored audience segments along with an overlap matrix to inform an optimized subsampling process which adjusts target selections to preserve the relative sizing, overlap, and mutual exclusivity contained in the representative dataset.

Audience creation and expansion models often result in the assignment of a score to each record in a database that represents their overall probability or propensity of being classified in the target.

FIG. 2 illustrates a sample dataset where 20 respondents contained in a dataset were independently scored across 3 targets informed by the same dataset.

Audience creation and expansion models are seeded by panels or subsets of census level datasets that are designed to be representative of overall patterns of consumer behavior.

FIG. 3 is an example of an estimated audience overlap matrix sourced from a representative sample used to inform the audience expansion model.

The disaggregate data that inform the seeding models is often not able to be transferred to parties that ingest the resultant modeled audiences due to privacy restrictions, desire to protect proprietary data assets, or the sheer scale of the data. However, an aggregated audience overlap matrix created from the source dataset can be mathematically decomposed to create the required inputs to inform the subsampling of consumers from a database of scored audience segments seeded by the dataset.

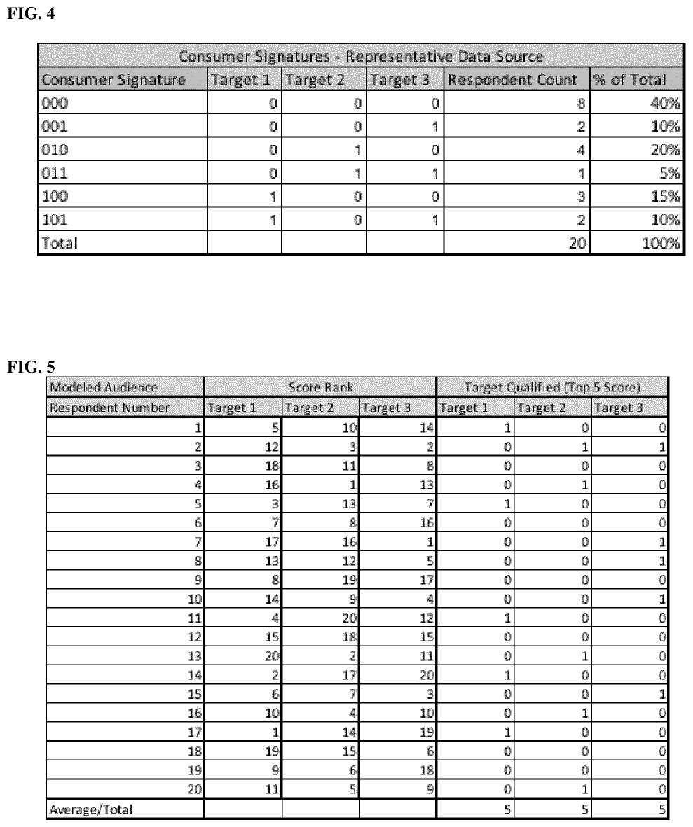

FIG. 4 represents the decomposition of the overlap matrix into the unique consumer signatures derived by leveraging graph theory to identifying the unique cliques within the matrix. A consumer signature is defined a string of bits reflecting target membership status across each of the audiences contained in the group. The consumer signature target membership information is then combined with the overlap matrix to derive the estimated counts within each signature.

A common use case of the results of audience scoring models is to select the top X % based on their score rank. For the purposes of simplification, the example presented in the illustrations uses a consistent size across all audiences. However, the methods outlined will preserve the relative sizing and overlap relationships as estimated by the representative dataset used to create the input overlap matrix.

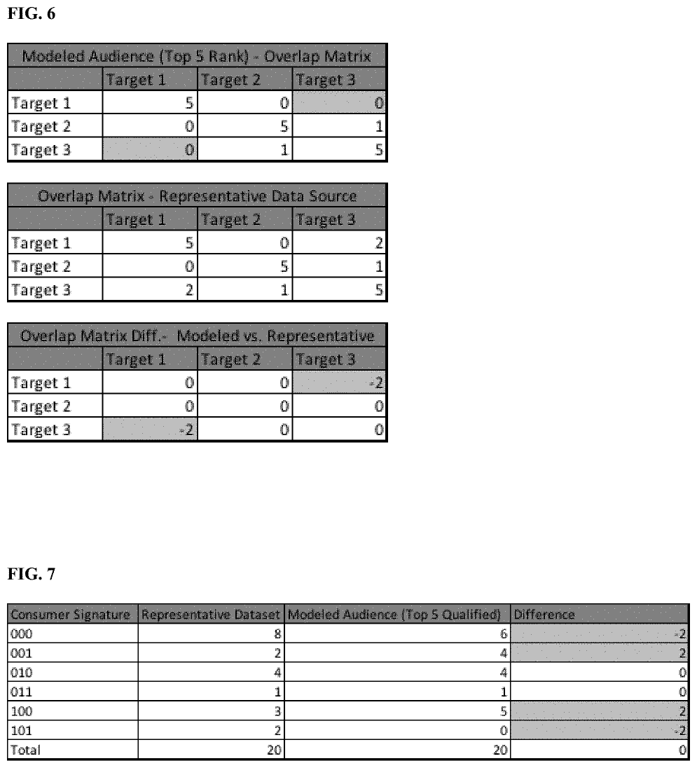

FIG. 5 illustrates the ranking of each respondent by propensity score and the selection of target audiences with a defined size of 5 each.

A starting point for the method is review the overlap matrix of the group of audiences being analyzing after applying the set of sizing standards and propensity score cutoffs that would normally be applied to the data.

FIG. 6 illustrates the resultant overlap matrix of the selection by top 5 rank by propensity score and the differences from the overlap matrix from the representative dataset. In the resultant selection, Target 1 and Target 3 have no overlapping respondents. In the representative dataset Target 1 and Target 3 have 2 out of 5 common respondents. In the representative dataset this 40% overlap would drive a significant level of correlation of metrics between Target 1 and Target 3.

Consumer signatures for the modeled audience database can be directly calculated from the disaggregate records without deriving from the respective overlap graph. The distribution of the consumer signatures is then compared to the distribution from the representative dataset. The differences between the distribution will indicate which consumer signatures are proportionally underrepresented and overrepresented by the default selection method was applied to the modeled audience database.

In practice, there often will be a need to scale the estimates from the representative database to align with the sizing of the consumer data containing the modeled audience segments. The goal of the process is to maintain the proportions of relative sizing and overlap as expressed by the representative dataset within the full scale of the consumer dataset containing modeled audience scores.

The adjusted consumer signature distribution from the representative dataset will define the optimal goals for an optimized subsampling process applied to the modeled audience database, and magnitude and direction of the differences from the initial selection of consumers from the modeled audience database will inform what adjustments are made. Aligning the consumer signatures will result in alignment of the overlap matrices between the modeled audience and representative datasets.

FIG. 7 illustrates the differences between the consumer signatures from the modeled audience and the representative dataset.

The subsampling adjustment process iteratively traverses the consumer signatures and prioritizes adjustments based on the magnitude of differences between the goal value and the initial modeled audience selection. The process seeks to minimize the number of target membership flags that need to be changed in a records consumer signature, while seeking to maintain a selection of consumers with relatively high score ranks across all targets. An implementation of the adjustment process can leverage parameter that defines the maximum desired % differences between the goals and optimized subsample can help provide configurable balance between the competing goals of fitting the sizing and overlap goals and the objective of maximizing the ranks of the selected adjusted target audiences.

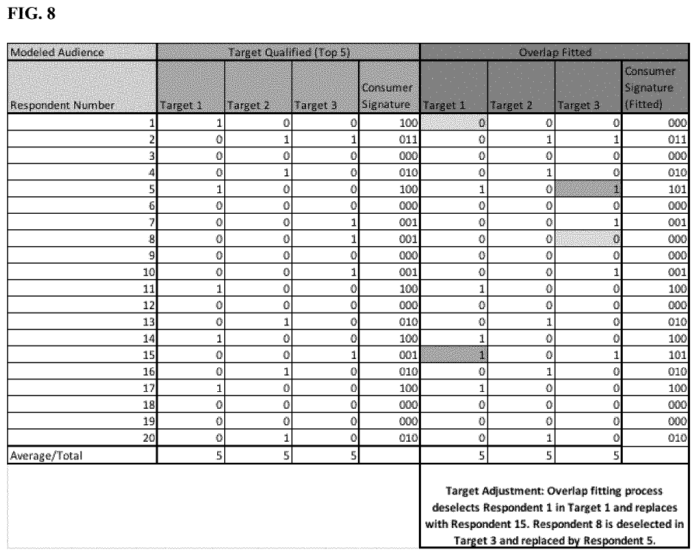

FIG. 8 Illustrates a sample adjustment process made to the target audience selection within the propensity score population to align the consumer signature distribution and overlap matrix to the target estimates defined by the representative dataset.

The results of the sample adjustment process yield an overlap matrix that is identical to the overlap matrix of the representative dataset.

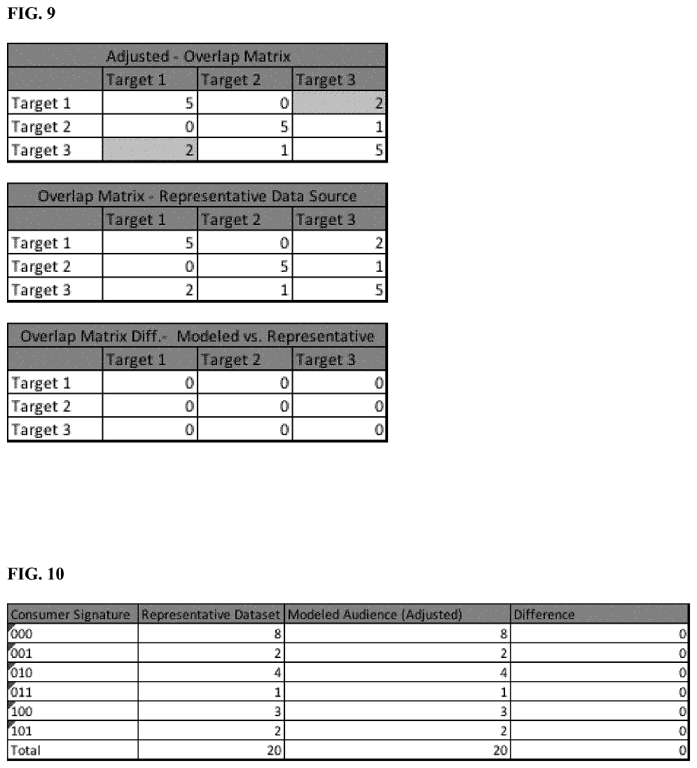

FIG. 9 illustrates the resultant overlap matrix of adjusted modeled audience selection and exact alignment with the overlap matrix from the representative dataset.

The results of the sample adjustment process yield a distribution across consumer signatures that is identical to the representative dataset.

FIG. 10 illustrates the resultant consumer signature distribution of adjusted modeled audience selection and exact alignment with the consumer signature distribution from the representative dataset.

What is claimed is:

1. A method to improve the subsampling from a group of independently modeled audience segments, said method being performed by a computing device arranged to connect to a consumer database comprising propensity scores across multiple target audiences, said method comprising the steps of:
(a) accessing, by said computing device, said consumer database for retrieving said propensity scores across said multiple target audiences thereby obtaining a modeled audience database,
(b) using, by said computing device, target audience membership data from a representative dataset to construct an overlap matrix of said multiple target audiences,
(c) decomposing, by said computing device, said overlap matrix into consumer signatures by identifying unique cliques comprised in said representative overlap matrix,
(d) calculating, by said computing device, an overlap matrix for a default assignment of target audiences in said modeled audience database,
(e) calculating, by said computing device, consumer signatures for records in the modeled audience database based on the default assignment,
(f) calculating, by said computing device, differences between representative dataset and initial target selection from the modeled audience database along the dimensions of the overlap matrix and consumer signature distribution,
(g) using, by said computing device, the overlap matrix and consumer signature profile taken from the representative database to inform an adjustment process that retains the proportional relationships of target audience sizing and overlap within the target audience selection within the modeled audience database.

2. The method in accordance with claim 1, wherein said propensity scores range from zero to one hundred for indicating a propensity of a consumer to a target audience.

3. The method in accordance with claim 1, wherein each consumer signature relates to a unique assignment of target audiences in said modeled audience database.

4. The method in accordance with claim 1, wherein each consumer signature is coupled to a respondent count indicating how often particular unique assignments of target audiences occurs.

5. The method in accordance with claim 1, wherein said step of using comprises informing said target audience selection within the modeled audience database.

6. A computing device arranged to connect to a consumer database comprising propensity scores across multiple target audiences, wherein said computing device is arranged to improve the subsampling from a group of independently modeled audience segments, said computing device comprising:
(a) access equipment arranged for accessing said consumer database for retrieving said propensity scores across said multiple target audiences thereby obtaining a modeled audience database,
(b) process equipment arranged for using target audience membership data from a representative dataset to construct an overlap matrix of said multiple target audiences,
(c) wherein said process equipment is further arranged for decomposing said overlap matrix into consumer signatures by identifying unique cliques comprised in said representative overlap matrix,
(d) wherein said process equipment is even further arranged for calculating an overlap matrix for a default assignment of target audiences in said modeled audience database,
(e) wherein said process equipment is even further arranged for calculating consumer signatures for records in the modeled audience database based on the default assignment,
(f) wherein said process equipment is even further arranged for calculating differences between representative dataset and initial target selection from the modeled audience database along the dimensions of the overlap matrix and consumer signature distribution,
(g) wherein said process equipment is even further arranged for using the overlap matrix and consumer signature profile taken from the representative database to inform an adjustment process that retains the proportional relationships of target audience sizing and overlap within the target audience selection within the modeled audience database.

7. The computing device in accordance with claim 6, wherein said propensity scores range from zero to one hundred for indicating a propensity of a consumer to a target audience.

8. The computing device in accordance with claim 6, wherein each consumer signature relates to a unique assignment of target audiences in said modeled audience database.

9. The computing device in accordance with claim 6, wherein each consumer signature is coupled to a respondent count indicating how often particular unique assignments of target audiences occurs.

10. The computing device in accordance with claim 6, wherein said process equipment is arranged for informing said target audience selection within the modeled audience database.
